(19) United States
(12) Patent Application Publication
(10) Pub. No.: US 2017/0283044 A1
(43) Pub. Date: Oct. 5, 2017

(54) DAMAGE ADAPTIVE VIBRATION CONTROL

(71) Applicant: Sikorsky Aircraft Corporation, Stratford, CT (US)

(72) Inventors: Jordan Alex Kaye, Stratford, CT (US); Michael Monico, Stratford, CT (US); Marcus D. Cappelli, Stratford, CT (US)

(21) Appl. No.: 15/509,762

(22) PCT Filed: Jul. 24, 2015
(86) PCT No.: PCT/US15/41966

§ 371 Date: Mar. 8, 2017

Related U.S. Application Data
(60) Provisional application No. 62/056,003, filed on Sep. 26, 2014.

(51) Int. Cl. B64C 27/00; F16F 15/10; B64D 45/00; F16F 15/00

(52) U.S. Cl. CPC B64C 27/001; F16F 15/002; F16F 15/10; B64D 45/00; F16F 2228/004; F16F 2228/04; F16F 2228/10; B64C 2027/004; B64C 2027/005; B64D 2045/0085

(57) ABSTRACT

A method of operating a vibration control system (VCS) using a single actuator which operates to attenuate a system frequency of a system is provided. The method includes determining whether current vibrations at a non-system frequency exceed a predefined level, determining a system response to compensate for the current vibrations exceeding the predefined level and adjusting the force response of the single actuator to respond to a system frequency and the non-system frequency according to the determined system response toward compensating for the current vibrations.

### CROSS-REFERENCE TO PRIOR APPLICATIONS

The present application is a 371 national stage of International Application No. PCT/US15/41966, filed on Jul. 24, 2015, which claims priority to U.S. Provisional Application No. 62/056,003, filed on Sep. 26, 2014, the contents of which are incorporated by reference herein in their entirety.

### FEDERAL RESEARCH STATEMENT

This invention was made with government support under W911W6-12-2-0005 awarded by the Army. The government has certain rights in the invention.

### BACKGROUND OF THE INVENTION

The subject matter disclosed herein relates to damage adaptive vibration control and, more particularly, to an aircraft including a damage adaptive vibration control system.

Vibration is a mechanical phenomenon whereby oscillations occur about an equilibrium point. The oscillations may be periodic, such as the motion of a pendulum, or random, such as the movement of a tire on a gravel road. While vibration in a given system is occasionally desirable, it is more often undesirable due to the tendency of vibrations to waste energy, create noise and have deleterious effects on mission performance. In aircraft operations, vibrations may be caused by normal rotor rotation or damage to the aircraft and are frequently of the undesirable type.

In some aircraft, particularly utility helicopters like Blackhawks, vibrations can be caused by damage due to hostile impacts, such as bullets. Where the damage is severe, the resulting vibrations may not be survivable or may be sufficient to require a mission abort. In some cases, the resulting vibrations lead to further damage that causes additional vibrations which themselves may not be survivable or may be sufficient to require a mission abort.

### BRIEF DESCRIPTION OF THE INVENTION

According to one aspect of the invention, a method of operating a vibration control system (VCS) using a single actuator which operates to attenuate a system frequency of a system is provided. The method includes determining whether current vibrations at a non-system frequency exceed a predefined level, determining a system response to compensate for the current vibrations exceeding the predefined level and adjusting the force response of the single actuator to respond to a system frequency and the non-system frequency according to the determined system response toward compensating for the current vibrations.

In accordance with additional or alternative embodiments, the method further includes determining whether the non-system frequency of the current vibrations exceed at least first or second predefined levels, adjusting the force response of the single actuator to execute a first action in accordance with the current vibrations being determined to exceed the first but not the second predefined level and adjusting the force response of the single actuator to execute a second action in accordance with the current vibrations being determined to exceed the first and the second predefined levels.

In accordance with additional or alternative embodiments, the first predefined level includes a first amplitude at a given range of frequencies and the second predefined level includes a second amplitude, which is higher than the first amplitude, at the given range of frequencies.

In accordance with additional or alternative embodiments, the first and second actions each include providing instructions in relation to a change of a current mission outcome.

In accordance with additional or alternative embodiments, the first action includes adjusting the force response of the single actuator to execute a first action to change of a mission abort outcome to a no-mission effect outcome.

In accordance with additional or alternative embodiments, the second action includes adjusting the force response of the single actuator to execute a second action to provide instructions to an operator to abort a mission instead of requiring a forced landing.

In accordance with additional or alternative embodiments, the employing of the determined system response includes changing via a controller of the VCS an operating frequency of the single actuator of the VCS to a new frequency to attenuate the non-system frequency of a system and operating the single actuator at the new frequency in addition to a normal frequency at which the single actuator which operates to attenuate the system frequency.

According to another aspect, a vibration control system (VCS) to attenuate vibrations on a frame is provided and includes an actuator to compensate for system and non-system frequency vibrations of the frame and a flight computer. The flight computer is disposed to sense current vibrations and to control operations of the actuator to operate a first frequency to attenuate the system frequency vibrations, to detect whether the current vibrations are at a non-system frequency which exceeds a predefined level, to determine a system response to compensate for the non-system frequency vibrations exceeding the predefined level and to control the actuator to additionally provide a second frequency to attenuate the non-system frequency vibrations to compensate for the system and non-system current vibrations.

In accordance with additional or alternative embodiments, the VCS includes at least one or more of hub mounted vibration suppressors (HMVSs) and circular force generators (CFGs).

In accordance with additional or alternative embodiments, the flight computer includes accelerometers disposed to sense the current vibrations.

In accordance with additional or alternative embodiments, the flight computer is disposed to control operations of the VCS by determining whether the current vibrations exceed at least first or second predefined levels and executing a first or second action in accordance with the current vibrations being determined to exceed the first but not the second predefined level or in accordance with the current vibrations being determined to exceed the first and the second predefined level, respectively.

In accordance with additional or alternative embodiments, the actuator includes rotational eccentric masses.

In accordance with additional or alternative embodiments, the actuator includes two rotational eccentric masses.

In accordance with additional or alternative embodiments, an aircraft includes the VCS and an airframe having an upper pylon and a tail, a main rotor assembly and a tail rotor at the upper pylon and the tail respectively, and engines to drive at least the main rotor assembly to provide lift and thrust to the airframe.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic diagram illustrating an exemplary computing system according to an embodiment of the invention;

FIG. 2A is a side view of a system for providing active vibration control (AVC) on an aircraft according to an embodiment of the invention;

FIG. 2B is a schematic diagram of a system for providing AVC according to an embodiment of the invention;

FIG. 3 is a flow chart of an exemplary method according to an embodiment of the invention;

FIGS. 4A-4H are schematic representations of an actuator for use in an active vibration control system according to an embodiment of the invention;

FIG. 5A depicts simulation data for the induced rotational speed of eccentric masses according to an embodiment of the invention;

FIG. 5B depicts simulation data for the induced inertial torque of the eccentric masses according to an embodiment of the invention;

FIG. 5C illustrates simulation data for a time domain response of the induced force in system according to an embodiment of the invention;

FIG. 5D is simulation data for a FFT spectrum to a disturbance in two eccentric mass according to an embodiment of the invention; and

FIG. 6 is a flow diagram illustrating a method of operating a vibration control system (VCS) in accordance with embodiments.

The detailed description explains embodiments of the invention, together with advantages and features, by way of example with reference to the drawings.

### DETAILED DESCRIPTION OF THE INVENTION

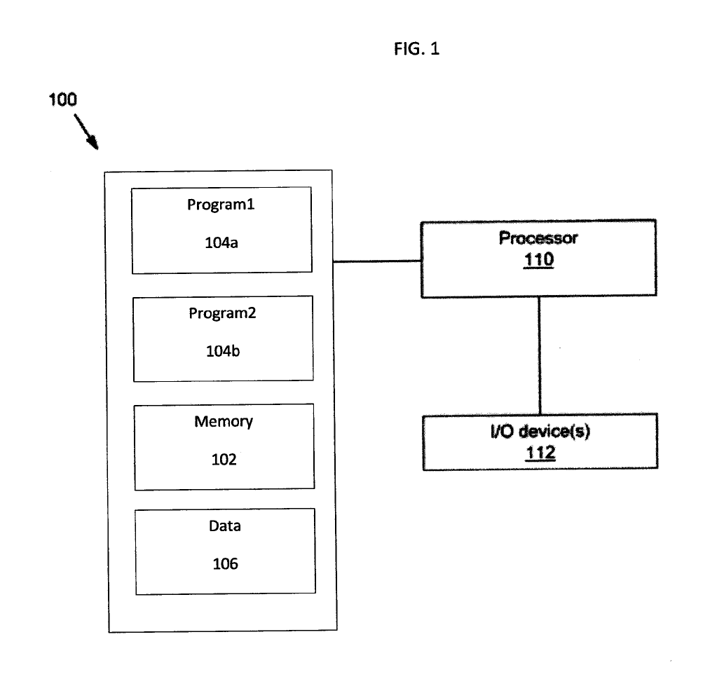

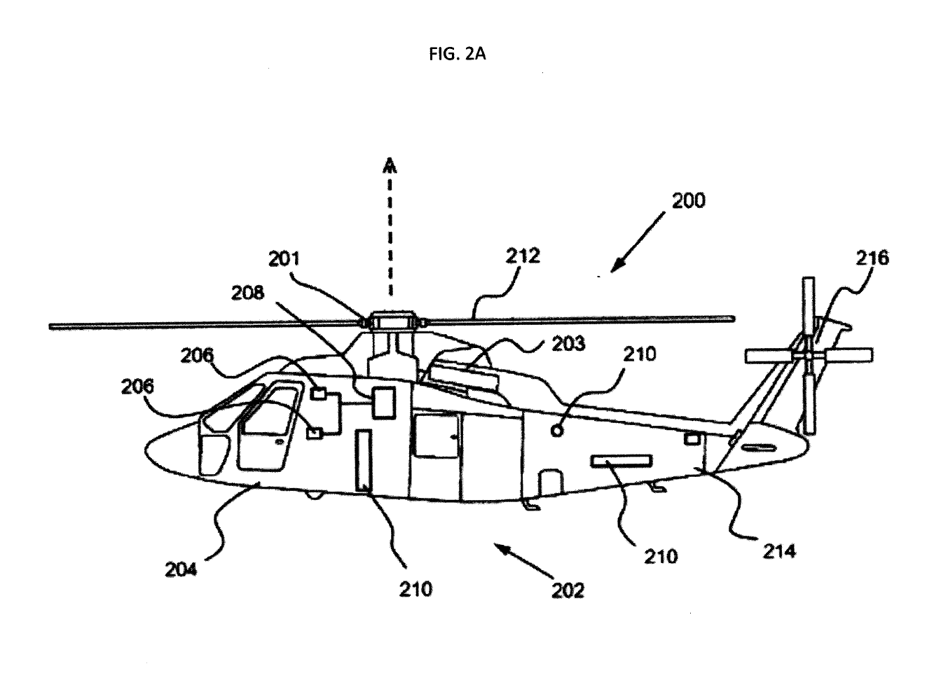

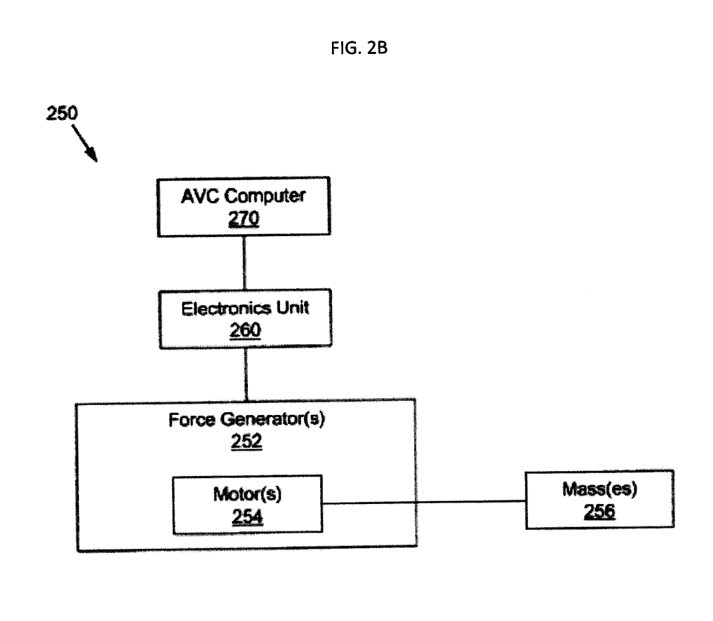

With reference to FIGS. 1, 2A and 2B, a flight computer 100 is implemented on aircraft 200 (FIG. 2A). The flight computer 100 includes a memory 102, on which executable instructions may be stored. The executable instructions may be stored or organized in any manner and at any level of abstraction, such as in connection with one or more processes, routines, methods, etc. As an example, at least a portion of the instructions are shown in FIG. 1 as being associated with a first program 104a and a second program 104b. The memory 102 may include random access memory (RAM), read only memory (ROM), or other electronic, optical, magnetic, or a combination of RAM, ROM, or other computer readable medium in the same or different locations connected over a network.

The memory 102 may be configured to store data 106. Data 106 may include data originating from one or more sources. The data 106 may pertain to one or more parameters, such as an eccentric rotational speed, force, torque, etc. The instructions stored in the memory 102 may be executed by one or more processors, such as a processor 110. The processor 110 may be configured to process the data 106. It is to be understood that the data 106 may be stored on separate media from the programs 104a, 104b.

The processor 110 may be coupled to one or more input/output (I/O) devices 112. In some embodiments, the I/O device(s) 112 may include one or more of a keyboard or keypad, a touchscreen or touch panel, a display screen, a microphone, a speaker, a mouse, a button, a remote control, a joystick, a printer, etc. The I/O device(s) 112 may be configured to provide an interface to allow a user or another entity (e.g., another computing entity) to interact with the flight computer 100. The device 112 may also be configured to transmit or receive sensor data and/or commands to the processor 110. The processor 110 communicates with the memory 102 and the I/O device 112 using wired and/or wireless protocols.

The flight computer 100 is illustrative. In some embodiments, one or more of the entities may be optional. In some embodiments, additional entities not shown may be included. In some embodiments, the entities may be arranged or organized in a manner different from what is shown in FIG. 1. One or more of the entities shown in FIG. 1 may be associated with one or more of the devices or entities described herein. FIG. 2A illustrates an aircraft system 202 that is configured to provide for an active vibration control (AVC) system on aircraft 200 according to an embodiment of the invention. The system 202 may be implemented in connection with the flight computer 100 of FIG. 1 on aircraft 200 as illustrated, but the invention is not limited thereto.

As illustrated in FIG. 2A, the aircraft 200 may be provided as a helicopter and includes an airframe 204 with aerodynamic elements, such as an upper pylon and a tail 214 with a tail rotor 216 located thereon. A main rotor assembly 201 is located at the upper pylon of the airframe 204 and rotates about a main rotor axis A. The tail rotor 216 and the main rotor assembly 201 may be collectively referred to as drive elements. The main rotor assembly 201 is driven by one or more engines 203 which causes rotation of blades 212 to provide lift and thrust to the airframe 204. The airframe 204 is lifted by the main rotor assembly 201 and houses sensors 206, actuator 210 and controller 208.

The rotation of the main rotor assembly 201 and the associated blades 212 may cause vibratory loads to be experienced by the airframe 204. To suppress vibration of the airframe 204 resulting from, for example, rotation of the main rotor assembly 201 about the main rotor axis A, a number of AVC actuators 210 are located in the airframe 204 or on the rotating hub as in the case of hub mounted vibration suppressors (HMVSs) that may be associated with one or more eccentric masses that are coupled to fuselage 204 in order to produce one or more outputs that may mitigate the impact or effect of the vibration caused by the main rotor assembly 201 for one of the frequencies, as well as mitigating a second vibration caused by an abnormal event, as will be described below in FIG. 2B.

The system 202 may include one or more sensors, such as a sensor 206 located on the airframe 204. The sensor 206 may be configured to detect or measure the extent of the vibration caused by the operation and use of the blades 212, potentially as a function of a rotational speed or rotational frequency associated with the main rotor assembly 201. In some embodiments, the sensor 206 may include one or more accelerometers. The sensor 206 may provide data pertaining to the vibration to a controller 208.

The controller 208 may be configured to process the data from the sensor 206. Based on the data processing, the controller 208 may cause one or more commands or directives to be issued to the actuator 210 which acts as an active vibration controller to offset or cancel vibratory loads on the airframe 204. In some embodiments, the commands or directives may serve to modulate an eccentric rotational speed associated with the actuator 210. In exemplary embodiments, the eccentric rotational speed is set at a first frequency. The eccentric rotational speed is modulated to a second frequency to provide a force output at two distinct frequencies. The controller 208 may include or be in communication with the flight computer 100 of FIG. 1.

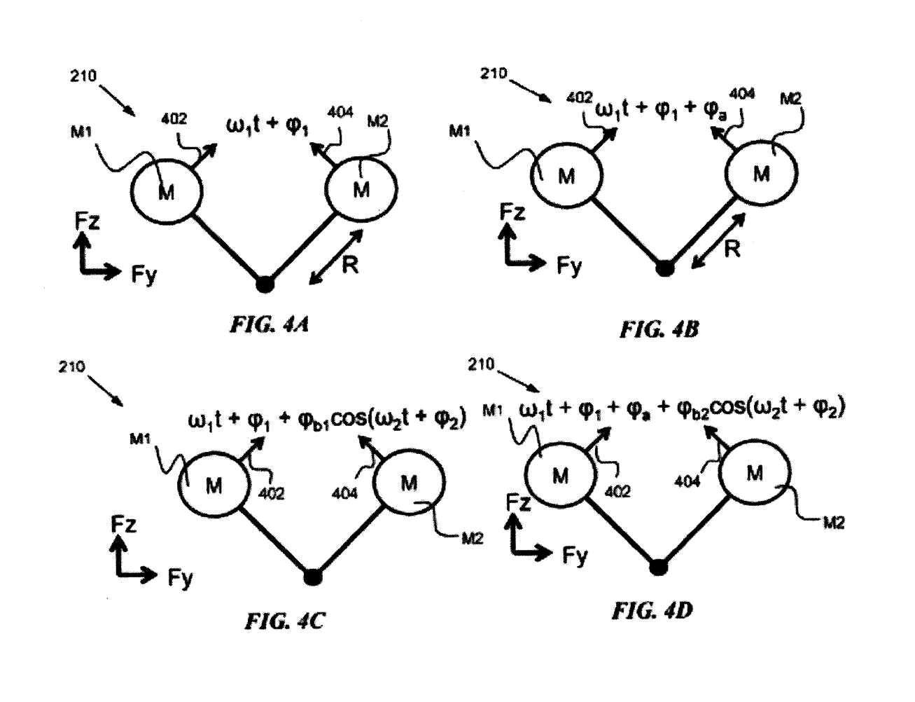

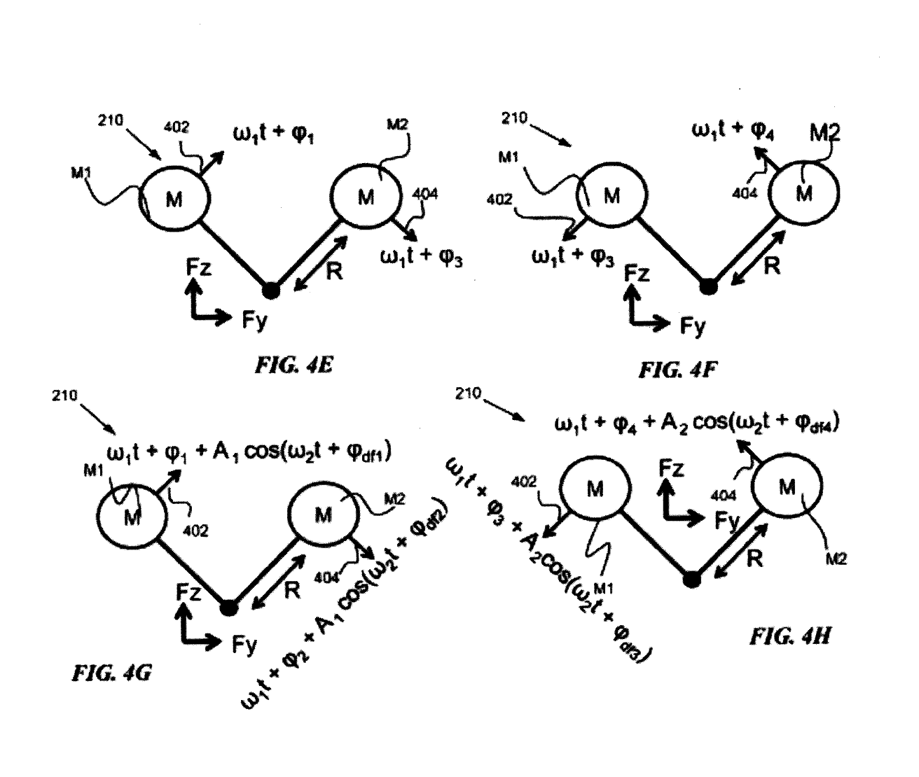

The actuator 210 may be associated with one or more eccentric masses (not shown). The actuator 210 may be configured to produce one or more outputs that may mitigate (e.g., cancel) the impact or effect of the vibration caused by the main rotor assembly 201 on the airframe 204. For example, the actuator 210 may be configured to control the mass(es) to produce a force that is approximately equal to (e.g., within a threshold of the magnitude of), but opposite in sign from, the forces generated as a result of the operation/vibration associated with the main rotor assembly 201. In some embodiments, the force produced or caused by the actuator 210 may be characterized by two (or more) distinct frequencies, as will be described below in FIGS. 4A-4H. In this manner, the system 202 may be used to control or mitigate a plurality of frequencies associated with the vibration caused by operating the main rotor assembly 201. The actuator 210 may include at least one or more of Hub Mounted Vibration Suppressor (HMVS) and circular force generators (CFGs).

Referring now to FIG. 2B, a system 250 for providing active vibration control (AVC) is illustrated. The system 250 includes a number of entities as described further below. The entities may be associated with, or include, one or more components or devices, such as those described herein. For example, the system 250 may include one or more of the components and devices described above with respect to the flight computer 100 and the aircraft 200 such as, for example, the actuators 210 and the controller 208.

As shown in FIG. 2B, the system 250 may include one or more mechanical units or force generators 252. The force generator 252 may include one or more motors 254. The force generator 252 or motor 254 may cause one or more eccentric masses 256 to spin to provide a force output that may serve to mitigate or counteract the impact of two or more vibration frequencies (e.g., 4/rev and 8/rev on an aircraft with four blades) according to aspects of the invention.

The force generator 252 may be coupled to an electronics unit 260. The electronics unit 260 may provide power to the force generator 252 to control the motor 254. The force generator 252 may provide feedback to the electronics unit 260 regarding the position or location of the eccentric masses 256. The electronics unit 260 may provide directives or commands to the force generator 252 regarding a desired position for the mass 256 in order to realize a damping effect at two or more of the vibration frequencies.

The electronics unit 260 may be coupled to an AVC computer 270. The electronics unit 260 may provide power to the AVC computer 270. The AVC computer 270 may be configured to receive data, such as data pertaining to accelerometer readings or measurements. Based on a processing of the data, the AVC computer 270 may calculate one or more parameters, such as an amplitude, phase, force, or frequency that should be realized by the force generators 252. The AVC computer 270 may provide such parameters to the electronics unit 260, and the electronics unit 260 may process the parameters to determine the desired position for the mass 256 as described above.

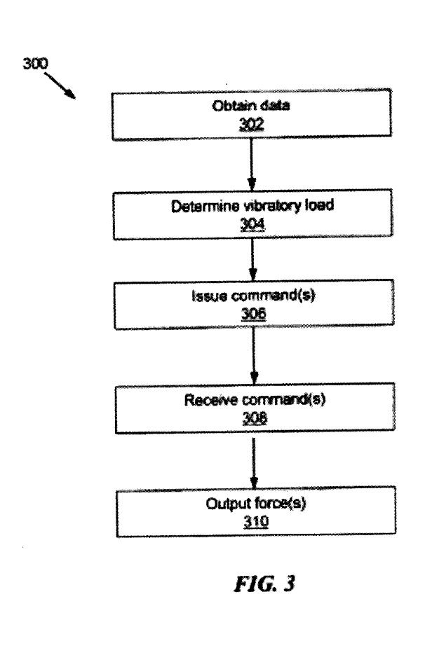

Turning to FIG. 3 with continued reference to FIG. 2A, a flow chart of an exemplary method 300 is shown. The method 300 may be executed in connection with one or more entities, components, devices, or systems, such as those described herein. The method 300 may be used to modulate an actuator eccentric rotational speed. In block 302, data may be obtained from one or more sources. For example, in connection with FIG. 2A, data may be obtained from the sensor(s) 206 as one or more signals. The obtained sensor data may be indicative of a vibratory load imposed on the airframe 204 of the aircraft 200 by the operation of an engine 203 or main rotor assembly 201. In block 304, a determination or calculation may be made regarding the vibratory load imposed on the airframe 204 based on the received sensor data obtained in block 302. The determination/calculation may be made by, e.g., a controller 208, but may also be performed by the flight computer 100 and relayed back to the controller 208 in other aspects. In block 306, one or more signals representative of commands or directives may be issued by, e.g., a controller 208. The commands/directives may serve to modulate an eccentric rotational speed associated with an actuator 210 selectable between one or more frequencies and two or more frequencies. In block 308, the one or more commands of block 306 may be received by, e.g., the actuator 208 as signals. In block 310, one or more forces may be output by, e.g., the actuator 210. The forces may be based on the received commands of block 308. The forces may be associated with more than one frequency.

FIGS. 4A-4H schematically represent a rotary actuator 210 (FIG. 2B) with eccentric masses M1, M2 which may be used in the system 250 according to an exemplary embodiment of the invention. As illustrated and with continued reference to FIG. 2B, the actuator 210 includes substantially similar concentric masses M1, M2 that may be co-rotated in the direction indicated by arrows 402, 404 by modulating the speed of the shaft that is connected to the masses M1, M2. In this manner, the actuator 210 can output at a single frequency for which the actuator 210 was optimized, but can also provide a second frequency to dampen other vibration caused by an event, such as that caused by battle damage, bird strike damage or other occurrence which creates a new vibration in the aircraft 200.

As the rotational frequency of a conventional rotor may be, for example, about 4.3 Hz, and with four blades, the blade passage frequency in such cases may be characterized as 4P (4 per rev) of 17.2 Hz. As such, the rotational speed (4P) of the mass M1, M2 is generally 17.2 Hertz (cycles per second) or 1032 revolution per minute (rpm) to mitigate the 17.2 Hz frequency. The masses M1, M2 may produce a single or two resonant frequencies in order to dampen 4P and 8P vibrations by the blades 212 (FIG. 2B). An eccentric mass M1, M2 on a shaft generates a centripetal force at the frequency of rotation because the mass is off-center from the shaft. The masses M1, M2 are connected to an airframe 204 (FIG. 2A) at selective modified distance R and are actuated by force generators(s) 252 (FIG. 2B to cause the masses M1, M2 to rotate at one or more angular speeds. The eccentric masses M1, M2 are displaced in parallel planes and may be tuned to produce two different resonant frequencies. The dual resonant frequencies (ω₁t, ω₂t) are 17.2 Hz and 34.4 Hz and are the frequencies at which the actuator 210 normally operates. In an embodiment, the rotary actuators 210 oppose the propagation of vibration by controlling the angular positions of the masses M1, M2 to produce single or dual frequency linear or biaxial forces to counteract the vibrations in the airframe 204 (FIG. 2A).

In the example illustrated in FIG. 4A-AB, each eccentric mass M1, M2 is illustrated as producing a linear output force component at a single frequency (ω₁t) through rotation in directions 402 and 404, according to Equations (1) and (2), where Fz is the force in the Z direction, Fy is the force in the Y direction, R is a radius to the masses M1, M2, t is time, φₐ is relative phase between masses, and φ₁ is force phase relative to some reference as follows:

Fz=4MRω₁²(1−(|mod(φₐ, +/−π)|/π)) cos(ω₁t+φ₁) (1)

Fy=0 (2)

In the example illustrated in FIG. 4C-4D, each eccentric mass M1, M2 is illustrated as producing a linear output force component at a dual frequency (ω₁t, ω₂t) according to Equations (3) through (5), where F2 is a force in the Z direction at frequency (ω₁+ω₂), φ_{b1} is the oscillatory phase of mass pair one, φ_{b2} is the oscillatory phase of mass pair two, and M is M1 or M2 as follows:

Fz=4MRω₁²(1−(|mod(φₐ, +/−π)|/π))cos(ω₁t+φ₁)+F₂cos((ω₁+ω₂)t+φ₂) (3)

Fy=0 (4)

F₂=g(φ_{b1}, φ_{b2}, M, R) (5)

In the example illustrated in FIG. 4E-4F, each eccentric mass M1, M2 is illustrated as producing a linear biaxial output force component at a single frequency (ω₁t, ω₂t) according to Equations (6) and (7):

Fz=4MRω₁²(1−(|mod(φₐ, +/−π)|/π))cos(ω₁t+φ₁) (6)

Fy=0 (7)

In the example illustrated in FIG. 4E-4F, each eccentric mass M1, M2 is illustrated as producing a linear biaxial output force component at a dual frequency (ω₁t, ω₂t) according to Equations (8) through (10):

Fz=4MRω₁²(1−(|mod(φₐ, +/−π)|/π))cos(ω₁t+φ₁)+F₂cos((ω₁+ω₂)t+φ₂) (8)

Fy=0 (9)

F₂=g(φ_{b1}, φ_{b2}, M, R) (10)

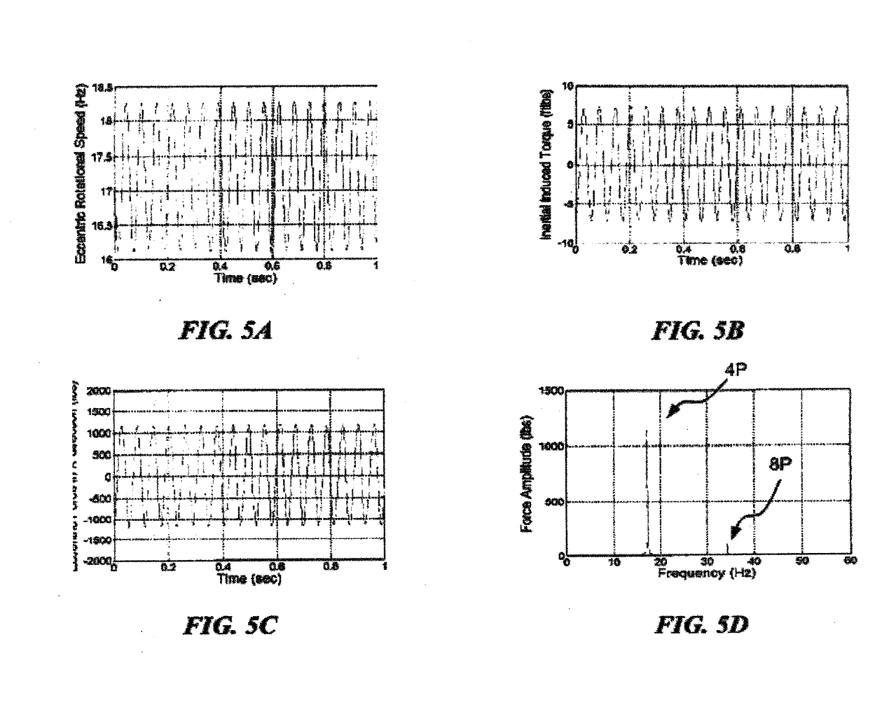

FIGS. 5A-5D are graphical representations of simulation data for modulating an eccentric mass such as, e.g., M1 or M2 of FIG. 4A-4H according to an embodiment of the invention. As illustrated, FIG. 5A depicts simulation data for the induced rotational speed of an eccentric mass M1 associated with a force generator 252. As illustrated in the figure, the resonant frequency that is being induced in the eccentric mass M1 by approximately 17.2 Hz which corresponds to 1032 revolution per minute (rpm) or 4 per rev of the rotors 212. It is to be appreciated that each force generator 252 includes two eccentric masses M1, M2 and an 8P harmonic response may be generated by modulating a rotational speed of a second eccentric mass, e.g., M2 through a first eccentric mass M1. FIG. 5B depicts, simulation data for the inertial torque that is being induced by eccentric mass M1 for a force generator 252. FIG. 5C illustrates simulation data for a time domain response of the induced force in system 250 (FIG. 2B) for eccentric mass M1. FIG. 5D is simulation data for a FFT spectrum relating to a disturbance in two eccentric mass(es) M1, M2 of which the two distinct frequencies at 4P and 8P are exhibited. As illustrated in FIG. 5D, by modulating an eccentric mass M1 at a rotational speed at 4 per rev and modulating a second mass M2 at 4 per rev produces a force component at 4 per rev and a smaller force component at 8 per rev. The modulation of the 4 per rev by changing the rotational speed and phase of, e.g., an eccentric mass M2 causes the second harmonic at 8P or 8 per rev to be generated (i.e., a controllable second induced force component). It is to be appreciated that the 8P harmonic can control the second harmonic by adjusting the phase and amplitude of the modulation. In some embodiments, an actuator eccentric rotational speed may be modulated. If the torque induced by the modulation is within motor limits, no additional weight penalty may be incurred (neglecting any potential housing requirements). Embodiments may be used to attenuate multiple vibratory frequencies associated with the operation of a rotor using a single AVC platform. Accordingly, the weight of an aircraft may be less than if a plurality of AVC platforms were used to attenuate a corresponding plurality of vibratory frequencies.

In some embodiments, energy harvesting may be performed. The energy harvesting may be based on a cyclic nature of a given modulation technique and may mitigate any additional power requirements that may be imposed.

Embodiments may be used to produce or generate a controllable force output at two or more frequencies. For example, in connection with the operation of a rotor with four blades, a force output may be generated at a fundamental frequency, which may be 4/rev in this example. The force output may include frequency components at multiples of the fundamental frequency (e.g., 8/rev, 12/rev, 16/rev, etc., in the case of a rotor with four blades). In some embodiments, the force output may include frequency components that are not multiples of the fundamental frequency. For example, integer variations or increments of the fundamental frequency (e.g., 5/rev, 6/rev, 7/rev, etc., in the case of a rotor with four blades) may be included in the force output.

Where the aircraft 200 is provided as a helicopter including the airframe 204 and the aerodynamic elements with the configurations described above, the drive elements (i.e., the tail rotor 216 and the main rotor assembly 201) may be configured for executing controlled, navigated flight operations. In addition, the system 250 may be provided as a vibration control system (VCS) that is disposed to compensate for system frequency vibrations of the airframe 204, the aerodynamic elements and the drive elements while the flight computer 100 is disposed to sense current vibrations by way of at least one sensor 206 and to control operations of the VCS. Such control by the flight computer 100 is provided by way of determination of whether the current vibrations are at a non-system frequency and if they exceed a predefined level, a determination of an amount of the VCS needed to compensate for the current vibrations exceeding the predefined level and an employment of the determined amount of the VCS toward compensating for the current vibrations.

Thus, in accordance with aspects, the VCS may be provided to operate as a damage adaptive VCS. That is, during a given mission, the aircraft 200 may experience damage causing events, such as an attack on the main rotor assembly 201 that results in substantial damage to that component. Such damage may lead to current vibrations of the aircraft 200 that, in some cases, may lead to a degradation of mission capabilities. For example, significant damage to the main rotor assembly 201 could lead to loss of the aircraft 200 (attrition), slightly less significant damage could lead to a forced landing of the aircraft 200 and lesser damage could lead to a reduction of mission operations. With the VCS being provided as a damage adaptive VCS, however, current vibrations associated with the significant or slightly less damages can be mitigated even in a case where a frequency of the current vibrations is not equal to a frequency at which the VCS is designed to operate.

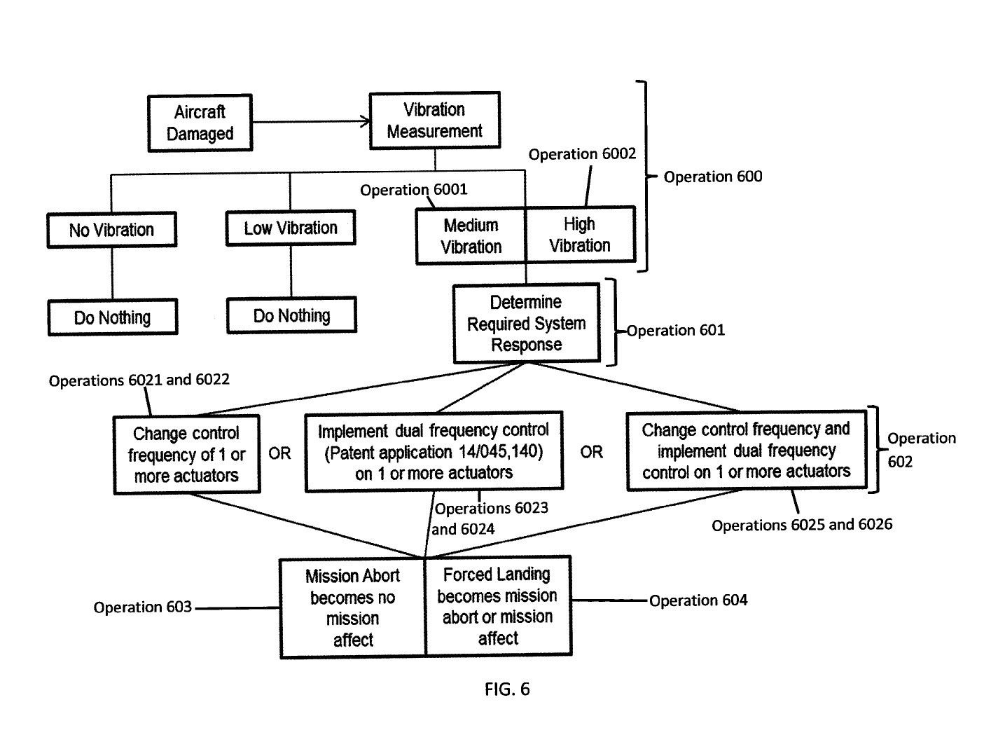

With reference to FIG. 6, a method of operating a vibration control system (VCS) of, for example, the aircraft 200 is provided. The method includes determining whether current vibrations at a non-system frequency (i.e., at a frequency at which the VCS is not designed to operate) exceed a predefined level (operation 600), determining a system response to compensate for the current vibrations exceeding the predefined level (operation 601) and employing the determined system response toward compensating for the current vibrations (operation 602).

More particularly, the method includes determining whether the current vibrations exceed at least a first predefined level (operation 6001), which is defined as and/or includes a first current vibration amplitude at a given range of non-system frequencies, or a second predefined level (operation 6002), which is defined as and/or includes a second current vibration amplitude that is higher than the first current vibration amplitude at a given range of non-system frequencies. Based on results of the determining of operations 6001 and 6002, the method further includes executing at least a first action in accordance with the current vibrations being determined to exceed the first but not the second predefined level (operation 603) and executing a second action in accordance with the current vibrations being determined to exceed the first and the second predefined levels (operation 604).

In accordance with embodiments, the first and second actions may each include a change of a current mission outcome where the change is made possible by the fact that the current vibrations, which would normally lead to a substantial mission capability change, are being mitigated and thus permit no such change or only a minor change. That is, the first action may be made in a case where the current vibrations exceed only the first predetermined level and thus the execution of the first action may include a change or downgrade of a mission abort outcome to a no-mission affect outcome. Similarly, the second change may be made in a case where the current vibrations exceed both the first and second predetermined levels and thus the execution of the second change may include a change or downgrade of a forced landing outcome to a mission abort outcome. In the second change, the pilot would be instructed, via audio and/or visual input, to abort the mission.

In accordance with further embodiments, the employing of the determined system response of operation 602 may include changing an operating frequency of one or more actuators 210 of the VCS to a new frequency (operation 6021) and operating the one or more actuators 210 of the VCS at the new frequency (operation 6022) where the new frequency is defined in accordance with a frequency of the current vibrations.

Alternatively, the employing of the determined system response of operation 602 may include implementing a dual frequency regime for one or more actuators 210 of the VCS (operation 6023). In such a dual frequency regime, a first new frequency range regime may be implemented for a first portion of the actuators 210 and a second new frequency range regime may be implemented for a second portion of the actuators 210. In such cases, the method may further include operating the first and second portions of the actuators 210 in the first and second new frequency range regimes, respectively (operation 6024), where the first and second new frequency range regimes are defined in accordance with frequency ranges of the current vibrations.

As another alternative, the employing of the determined system response of operation 602 may include changing an operating frequency of one or more actuators 210 of the VCS to a new frequency and additionally operating the one or more actuators 210 in a dual frequency regime (operation 6025). In such cases, the method may further include operating the one or more actuators 210 in the new frequency or the dual frequency regime (operation 6026).

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method of operating a vibration control system (VCS) using a single actuator which operates to attenuate a system frequency of a system, the method comprising:
determining whether current vibrations at a non-system frequency exceed a predefined level;
determining a system response to compensate for the current vibrations exceeding the predefined level; and
adjusting the force response of the single actuator to respond to a system frequency and the non-system frequency according to the determined system response toward compensating for the current vibrations.

2. The method according to claim 1, further comprising:
determining whether the non-system frequency of the current vibrations exceed at least first or second predefined levels;
adjusting the force response of the single actuator to execute a first action in accordance with the current vibrations being determined to exceed the first but not the second predefined level; and
adjusting the force response of the single actuator to execute a second action in accordance with the current vibrations being determined to exceed the first and the second predefined levels.

3. The method according to claim 1, wherein the first predefined level comprises a first amplitude at a given range of frequencies and the second predefined level comprises a second amplitude, which is higher than the first amplitude, at the given range of frequencies.

4. The method according to claim 1, wherein the first and second actions each comprise providing instructions in relation to a change of a current mission outcome.

5. The method according to claim 1, wherein the first action comprises adjusting the adjusting the force response of the single actuator to execute a first action to change of a mission abort outcome to a no-mission effect outcome.

6. The method according to claim 1, wherein the second action comprises adjusting the adjusting the force response of the single actuator to execute a second action to provide instructions to an operator to abort a mission instead of requiring a forced landing.

7. The method according to claim 1, wherein the employing of the determined system response comprises:
changing via a controller of the VCS an operating frequency of the single actuator of the VCS to a new frequency to attenuate the non-system frequency of a system; and
operating the single actuator at the new frequency in addition to a normal frequency at which the single actuator which operates to attenuate the system frequency.

8. A vibration control system (VCS) to attenuate vibrations on a frame, the VCS comprising:
an actuator to compensate for system and non-system frequency vibrations of the frame; and
a flight computer disposed to sense current vibrations and to control operations of the actuator to operate a first frequency to attenuate the system frequency vibrations, to detect whether the current vibrations are at a non-system frequency which exceeds a predefined level, to determine a system response to compensate for the non-system frequency vibrations exceeding the predefined level and to control the actuator to additionally provide a second frequency to attenuate the non-system frequency vibrations to compensate for the system and non-system current vibrations.

9. The VCS according to claim 8, further comprising at least one or more of hub mounted vibration suppressors (HMVSs) and circular force generators (CFGs).

10. The VCS according to claim 8, wherein the flight computer comprises accelerometers disposed to sense the current vibrations.

11. The VCS according to claim 8, wherein the flight computer is disposed to control operations of the VCS by determining whether the current vibrations exceed at least first or second predefined levels and executing a first or second action in accordance with the current vibrations being determined to exceed the first but not the second predefined level or in accordance with the current vibrations being determined to exceed the first and the second predefined level, respectively.

12. The VCS according to claim 8, wherein the actuator comprises rotational eccentric masses.

13. The VCS according to claim 8, wherein the actuator comprises two rotational eccentric masses.

14. An aircraft, comprising the VCS according to claim 8 and further comprising:
an airframe having an upper pylon and a tail;
a main rotor assembly and a tail rotor at the upper pylon and the tail respectively;
engines to drive at least the main rotor assembly to provide lift and thrust to the airframe.
